(19) United States
(12) Patent Application Publication
(10) Pub. No.: US 2017/0150065 A1
(43) Pub. Date: May 25, 2017

(54) System And Method For Producing A Background Or Cover Image

(71) Applicant: Daniel W. Lowry, Oxnard, CA (US)

(72) Inventor: Daniel W. Lowry, Oxnard, CA (US)

(21) Appl. No.: 14/948,834

(22) Filed: Nov. 23, 2015

(51) Int. Cl. H04N 5/262; H04N 1/00; H04N 1/393; H04N 5/232

(52) U.S. Cl. CPC H04N 5/2628; H04N 5/23222; H04N 1/00244; H04N 1/393; H04N 2201/0084

(57) ABSTRACT

A system and method for producing a background or cover image that functions in combination with a mobile device having image capture capability. The system and method utilizes a software program, preferably in the form of a software application, or app, which is designed to perfectly scale or size a captured image to fit within required image layout dimensions. The requiring layout dimensions are typically utilized for a background image or a cover image on a social media website. During use, the software program/app will allow a person to capture an image that will be used as a background or cover image, automatically scale or size the image to the required layout dimensions, and load the scaled/sized image onto the person's social media page. Alternately, the image can also be sent to another location for further editing and/or processing.

### TECHNICAL FIELD

The invention generally pertains to photographic applications, and more particularly to a system and method for producing a scaled/sized image that is primarily used as a background or cover image.

### BACKGROUND ART

Today, throughout the world, the internet has become the most widely-used method of communication and data sharing. E-commerce has become the de facto standard practice among corporations, companies and individuals. One of the most popular means of on-line communication and commence are social media websites. Currently, the largest and most widely used social media website is Facebook.

Typically, a person or company who uses a social media website will have their own “page”. It is on this page that a person will list their favorite interests, things to do, hobbies, as well as favorite music, films, television shows or any subject that interests them. A company will usually describe/show their products or services and explain why they are the best in their field.

Other users of the social media website can then interact with each other, On Facebook, for example, common groups of individuals are identified as “Friends”. A person's (or companies) popularity, (or acceptance among the public) can be determined by the number of friends a person or company has. Any shared information on a social media website can also be judged as “liked” by the users.

One of the most important aspects of having a social media page is the ability to personalize the page with visual images that reflects a person's individual taste.

Unfortunately, most social media websites have set size requirements for both background and cover images that are on a user's page. Unless an image is captured correctly sized, the image will not correctly fit on the page. While capturing a correctly sized image is not impossible, it is very difficult.

Obviously, what is needed is a way by which a captured image could be automatically scaled or sized to fit within the requirements of a social media website page. By use of this, any captured image would be scaled or sized, and then, if desired, automatically loaded onto a person's social media page: The optimal implementation would be by use of a software program in the form of an app. The app could be pre-loaded on any camera-equipped mobile device, or the app could be downloadable. To use the app, a person would simply choose the social media page, scaling or sizing further from the device's menu/screen, and then capture the image. Any additional or other functionally would be automatic.

A search of the prior art did not disclose any literature or patents that read directly on the claims of the instant invention. However, the following U.S. patents are considered related:

| PAT. NO. | INVENTOR | ISSUED |
|---|---|---|
| 5,485,563 | Fisher | 16 Jan. 1996 |
| 7,536,062 | Lippincott | 19 May 2009 |
| 8,605,119 | Bankhead et al | 10 Dec. 2013 |
| 2015/0262337 | Yoon et al | 17 Sep. 2015 |

The U.S. Pat. No. 5,485,563 patent discloses a system for building scaled images of an original in which a scaled image is sequentially built by scaling different portions of the original image and by combining the scaled different portions to obtain the scaled image. The system includes an image input section, an image portion selector, an image scaler, and a combiner for combining scale images. The portion selector selects respective first and second portions of the original, and the scaler forms respective first and second images of the selected portion. The combiner combines the first and second images so as to obtain a scaled image.

The U.S. Pat. No. 7,536,062 patent discloses a graphic image that has pixels arranged in rows and columns and that is scaled by processing a succession of segments. The processing of each segment produces and intermediate pixel which form a stream. The intermediate stream of pixels is processed form a final 2wo-dimensional scale image.

The U.S. Pat. No. 8,605,119 patent discloses identifying, scalable parts and unscalable parts of image modules that are to be scaled to fit within a fixed dimension and determining scaling factors that are to be applied to the scalable parts of the image. The scaling factors applied to the scalable parts of the images fit within the fixed dimension and the unscalable parts are unaffected by the scaling factors.

The 2015/0262337 publication discloses a reconfigurable image scaling circuit including a horizontal scalar, a bufferer, and a vertical scalar. The horizontal scalar is configured to generate horizontally scaled image data. The bufferer includes a mapper and a plurality of buffers. The plurality of buffers are configured to store the horizontally scaled image data. The vertical scalar is configured to generate an output image by scaling the horizontally scaled image vertically.

For background purposes and indicative of the art to which the invention relates, reference may be made to the following remaining patents found in the patent search.

| PAT. NO. | INVENTOR | ISSUED |
|---|---|---|
| 5,046,117 | Yamashita | 3 Sept. 1991 |
| 6,714,218 | Bian | 30 Mar. 2004 |
| 2002/0154123 | Harasimiuk | 24 Oct. 2002 |
| 2012/0236008 | Yamada et al | 20 Sept. 2012 |

### DISCLOSURE OF THE INVENTION

In its basic design, the system and method for producing a background or cover image is comprised of a software program that functions in combination with a mobile device. The software program is preferably in the form of a computer software application, or “app”. The mobile device can consist of any conventional device that has a camera function and a screen, which is preferably a TFT or touch screen. Examples of usable mobile devices include a cell phone, a smart phone, a tablet computer or even a digital camera.

The software is specifically designed to perfectly scale or size a captured image to fit within selected layout dimensions, which are typically used by social media websites such as Facebook. The software/app will allow a person to capture an image, have the image automatically scaled or sized to the layout dimensional required by the social media website, and then have the image uploaded onto the person's selected social media website. Alternatively, the image can be sent to another location, for example, to a person's background image pro account or to other proprietary or non-proprietary locations.

The software program is preferably pre-loaded on the mobile device, but the software program can also be loaded onto a mobile device that does not come with the software program. Depending on the business strategy, the software program can either be sold to a user, or offered free as an incentive to use certain other products or programs.

When the software is used on certain devices, such as a camera, especially when a device will come preloaded with the software, a button or switch, possibly in combination with an X-Y controller or joystick, can be used to actuate and/or control the software program's commands/menu options.

In view of the above disclosure, the primary object of the invention is to provide a system and method for producing a background or cover image that facilitates the addition of a perfectly scaled or sized background or cover image, preferably to a person's social media website page.

In addition to the primary object, it is also an object of the invention to provide a system and method for producing a background or cover image that:
is easy to use,
requires a minimal number of steps,
can be sold as pre-loaded software on a device, or as downloadable software,
does not interfere with any other function on a mobile device,
allows virtually any capturable image to be used as a background or cover image on a social media website,
adds to ability of a user to personalize his/her social media website,
is cost effective and value increasing from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a front elevational view of an image that has been modified by the system and method having an outline box showing the scaled or sized boundaries of the image as a background image or cover image per the requirements of a social media website.

FIG. 2 is a front elevational view of a camera having a button or switch for actuating the system.

FIG. 3 is a block diagram showing the steps of the method.

### BEST MODE FOR CARRYING OUT THE INVENTION

The best mode for carrying out the invention is presented in terms that disclose a preferred embodiment of a system and method for producing a background or cover image (hereinafter “system” and/or “method”) 10. One of the most popular capabilities of a social media (also known as a social network) website, such as Facebook, is that a person can customize their “page” with selected images. Typically, two of the images found on a social media website are a background image, which as its named implies is located behind text on the page, and a cover image which is often prominently visible when a person's social media page is opened. Both of these images are user-selectable, but both images have pre-defined layout dimensions that must be adhered to. Basically, any image that is selected as a background image or cover image must fit within the social media's layout dimensions. The instant system and method 10 provides a solution to producing a correctly scaled or sized image 12 for use as a background image or a cover image on a social media website.

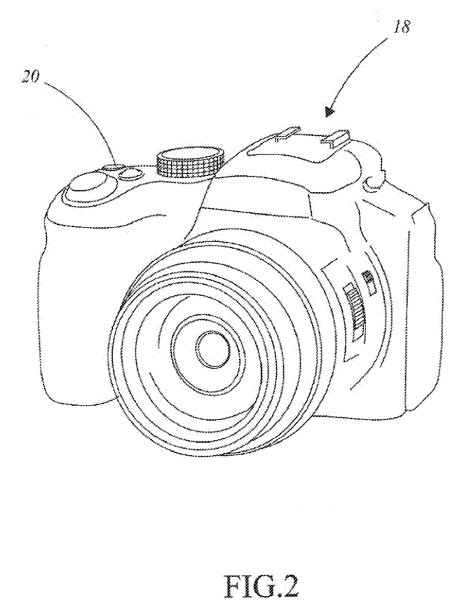

The system and method 10 functions in combination with a mobile device having image capture capability. The mobile device will typically be comprised of a wireless telephone, either a cell phone or a smart phone, or a tablet computer. The system and method 10 can also function with a conventional digital camera 18, as shown in FIG. 2, optionally with a button or switch 20 and X-Y controller. To activate and use the system or method 10 a software program is either downloaded onto a mobile device, or the software program can be pre-loaded onto a device.

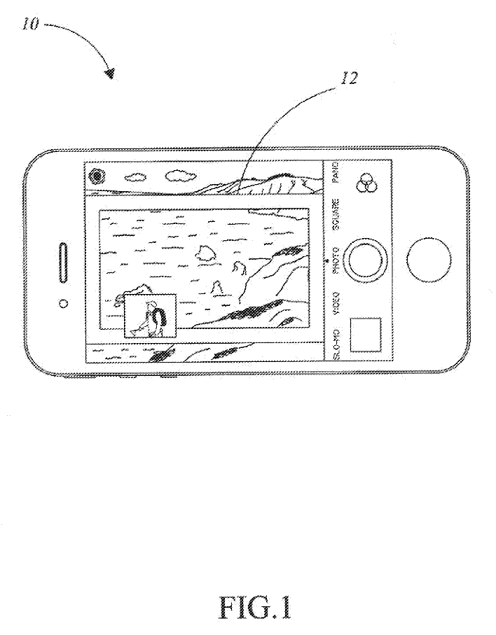

The system and method 10 utilizes the software program that is loaded onto the mobile device. The software program, which is preferably in the form of a software application or app, provides functional commands that, when an image is captured, causes the image to be scaled or sized to fit within the layout dimensions required by the social media website. The software program/app is accessed and controlled from the mobile device's screen, which is typically a touch screen. Once the software program/app is opened, a menu will appear on the screen. The menu will allow the user to select which function(s) he/she wants to perform. Since the software program/app performs which a specific function, the number of menu items or commands is limited, which makes the software program/app easy to use. The main functional application, which is the scaling or sizing of an image, is performed automatically once the software program/app is actuated. As previously disclosed, the scaling or sizing of an image, as shown in FIG. 1, is determined by the layout dimensions requirements set forth by the social media website. The layout dimension requirements are programmed into the software program/app. Any number of layout dimension requirements, from multiple social media websites, can be accessed and selected.

Once an image has been captured on a mobile device, and the image has been scaled or sized to the correct background image or cover image layout dimensions for a specific social media website, the image is automatically sent to, and loaded onto, the user's social media website page. Alternately, an image can also be sent to a selected internet location, or cloud. An example of an alternate internet location would be an internet-based account for users of the system and method 10.

In order to add to the utility of the system and method 10, the software program/app can be produced as open code, which allows users to modify the program per their requirements or desire. Additionally, the capability of sharing a single software program/app among multiple mobile devices can also be implemented.

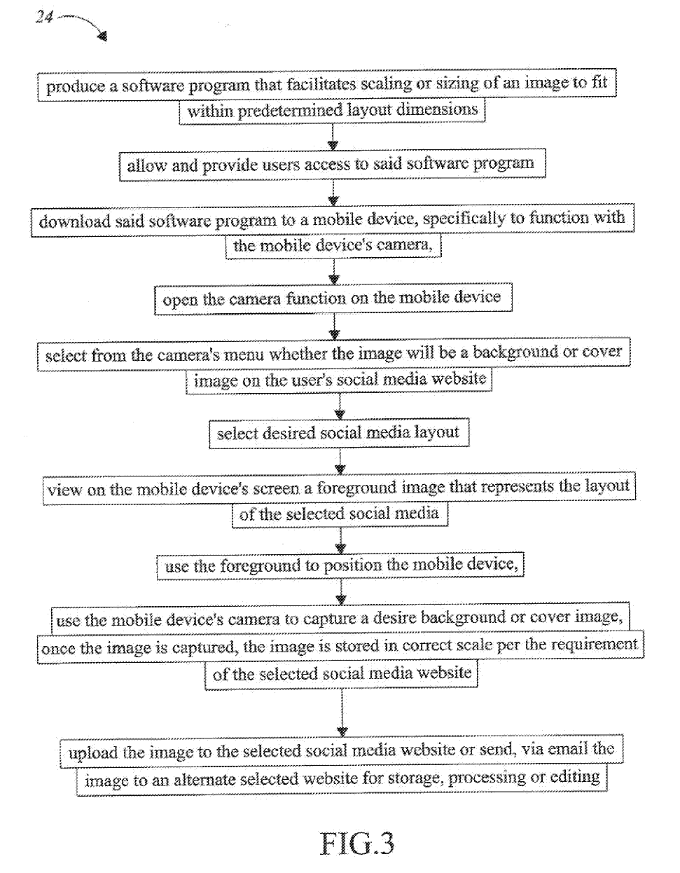

In order to use the system and method 10, the following steps 24, which are shown in block diagram in FIG. 3, are performed:

a) produce a software program that facilitates scaling or sizing of an image to fit within predetermined layout dimensions,

b) allow and provide users access to said software program,

c) download said software program to a mobile device, specifically to function with the mobile device's camera,

d) open the camera function on the mobile device,

e) select from the camera's menu whether the image will be a background or cover image on the user's social media website.

f) select desired social media layout,

g) view on the mobile device's screen a foreground image that represents the layout of the selected social media,

h) use the foreground to position the mobile device,

i) use the mobile device's camera to capture a desired background or cover image, wherein once the image is captured, the image is stored in correct scale per the requirement of the selected social media website, and

j) upload the image to the selected social media website or send, via email, the image to an alternate selected website for storage, processing or editing.

It should be noted that while the inventive functionality disclosed herein is designed to be used with current social media platforms, it is anticipated that in the future, other requirements may become necessary. The instant software and method 10 is designed and intended to be functionally applicable to any/all requirements that become necessary or relevant in the future.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A system and method for producing a background or cover image, wherein said system functions in combination with a mobile device having image capture capabilities, wherein said system comprises a software program that is loaded onto the mobile device, wherein said software program provides functional commands that, when an image is captured, causes the image to be scaled or sized to fit within predetermined layout dimensions.

2. The system and method for producing a background or cover image as specified in claim 1 wherein the mobile device is comprised of a cell phone.

3. The system and method for producing a background or cover image as specified in claim 2 wherein the cell phone is a smart phone.

4. The system and method for producing a background or cover image as specified in claim 1 wherein the mobile device is a tablet computer.

5. The system and method for producing a background or cover image as specified in claim 1 wherein the mobile device is a camera, wherein a captured image is stored in the camera's memory and is transferred to a selected location.

6. The system and method for producing a background or cover image as specified in claim 1 wherein said software program is comprised of a software application or “app”.

7. The system and method for producing a background or cover image as specified in claim 1 wherein said software program comes pre-loaded in the mobile device.

8. The system and method for producing a background or cover image as specified in claim 1 wherein said software program id downloaded into the mobile device.

9. The system and method for producing a background or cover image as specified in claim 1 wherein said software program is open code, which allows an end-user to modify said software program.

10. The system and method for producing a background or cover image as specified in claim 1 wherein said software program is activated and said software program commands are controlled by a menu that is accessible and viewable on a screen located on the mobile device.

11. The system and method for producing a background or cover image as specified in claim 1 wherein said software program is activated by a button or switch located on the mobile device, and said software program commands are controlled by a joystick or an X-Y controller located on the mobile device.

12. The system and method for producing a background or cover image as specified in claim 1 wherein the predetermined layout dimensions are utilized on a social media website.

13. The system and method for producing a background or cover image as specified in claim 1 wherein said scaled or sized image is stored on the mobile device.

14. The system and method for producing a background or cover image as specified in claim 1 wherein said scaled or sized image is automatically sent to, and loaded onto, a user's social media website.

15. The system and method for producing a background or cover image as specified in claim 1 wherein said scale or sized image is automatically sent to, and stored in, a specific internet location or cloud.

16. The system and method for producing a background or cover image as specified in claim 1 wherein the specific internet location is an internet based account for users of said system.

17. The system and method for producing a background or cover image as specified in claim 1 wherein when said software program is purchased, said software program is used or shared on multiple mobile devices.

18. A system and method for producing a background or cover image, wherein said method comprises the following steps:
a) produce a software program that facilitates scaling or sizing of an image to fit within predetermined layout dimensions,
b) allow and provide users access to said software program,
c) download said software program to a mobile device, specifically to function with the mobile device's camera,
d) open the camera function on the mobile device,
e) select from the camera's menu whether the image will be a background or cover image on the user's social media website.
f) select desired social media layout,
g) view on the mobile device's screen a foreground image that represents the layout of the selected social media,
h) use the foreground to position the mobile device,
i) use the mobile device's camera to capture a desired background or cover image, wherein once the image is captured, the image is stored in correct scale per the requirement of the selected social media website, and
j) upload the image to the selected social media website or send, via email, the image to an alternate selected website for storage, processing or editing.

19. The system and method for producing a background or cover image as specified in claim 18 wherein said software program is pre-loaded on a mobile device.

20. The system and method for producing a background or cover image as specified in claim 18 wherein the mobile device is selected from the group consisting of a cell phone, a smart phone, a tablet computer, or a camera.
